(19) United States
(12) Patent Application Publication
(10) Pub. No.: US 2019/0363943 A1
(43) Pub. Date: Nov. 28, 2019

(54) SYSTEMS AND METHODS FOR DETERMINING CHARACTERISTICS OF DEVICES ON A NETWORK

(71) Applicant: Fing Limited, Dublin (IE)

(72) Inventors: Marco De Angelis, Rome (IT); Carlo Medas, Rome (IT)

(73) Assignee: Fing Limited, Dublin (IE)

(21) Appl. No.: 16/418,169

(22) Filed: May 21, 2019

Related U.S. Application Data
(60) Provisional application No. 62/675,013, filed on May 22, 2018.

(51) Int. Cl. H04L 12/24; H04L 29/06

(52) U.S. Cl. CPC H04L 41/12; H04L 69/28

(57) ABSTRACT

Embodiments of the present invention provide techniques, systems, and methods for determining and modifying a device timeout of the connection of a device on a network and for using a coefficient of adhesion to determine device state data. Network protocols utilized by the device on the network may be determined based on a determined category of the device. A device timeout may be calculated based on the category and the network protocols. Device data, including state data of the device on the network may be obtained, and analyzed to determine at least one statistic value for the device state data. The device timeout may be modified based on the at least one statistic value. In addition, device data, corresponding to the device may be obtained and analyzed to determine a coefficient of adhesion. State data of the device on the network may be determined based on the coefficient of adhesion.

### CROSS REFERENCE TO RELATED APPLICATIONS

This U.S. Non-Provisional Patent Application claims priority to and benefit of U.S. Provisional Patent Application No. 62/675,013 filed May 22, 2018, which is hereby incorporated by reference herein in its entirety.

### BACKGROUND

As networked devices become more pervasive throughout enterprises, it is increasingly difficult to manage and identify all the devices connected to a network, and to determine characteristics of the devices, such as the conditions for a device to disconnect from a network. Not only are telecommunication devices logged onto networks, but other consumer electronic devices are enabled with network connectivity, including personal items (e.g., pedometers and watches), medical devices, household appliances, and vehicles. Each may use different communications protocols and each may have different device characteristics. Further, it is increasingly difficult to determine the presence of devices connected to a network and manage their network access, for example to control the storage of sensitive data on devices connected to the network. There is a need for systems and methods of recognizing devices connected to a network, and determining their device characteristics, in order to monitor, manage, and secure them.

Existing techniques of digital presence detection have several problems. For example, existing techniques use the Hypertext Transfer Protocol (HTTP) standard, which defines user-agent strings as the default way to provide information about a device sending a request to a web server on a network. However, the HTTP standard does not define how user-agent strings are created, resulting in inconsistent keywords in user-agent strings across browsers and devices. The inconsistent user-agent strings may hide true identifying information about the device. Consequently, analysis of standard HTTP protocol information does not always result in accurate identification of the devices.

### BRIEF SUMMARY OF THE INVENTION

In accordance with an aspect of an embodiment of the invention, a computer-implemented method is provided that includes the steps of: determining a category of a device on a network; determining network protocols utilized by the device based on the category; calculating a timeout for the device disconnection, based on the category and the network protocols; obtaining, using a presence detection system, device data corresponding to the device and including state data of the device; analyzing, using the presence detection system, the device data to determine at least one statistic value for the state data of the device; and modifying the device timeout based on the at least one statistic value. The device data may be obtained during a predetermined observation window of time. The state data of the device may be related to one of an offline state and an online state. The state data of the device may include at least one of a number of changes to a state of the device and a duration associated with the state of the device. The at-least-one statistic value may include a maximum number of changes to a state of the device during the predetermined observation window of time, and the device timeout may be modified based on the maximum of the number of changes to the state of the device. The at-least-one statistic value may include a maximum offline duration of the device during the predetermined observation window of time, and the device timeout may be modified based on the maximum offline duration of the device. The statistic value may be one of a maximum number of changes to the state of the device, a minimum offline duration of the device, a maximum offline duration of the device, an average offline duration of the device, and a median offline duration of the device.

In accordance with another aspect of an embodiment of the invention, a digital presence detection system is provided that includes: a processor and a non-transitory computer-readable medium storing instructions executable by the processor to: determine a category of a device on a network; determine network protocols utilized by the device based on its category; calculate a device timeout for the device based on its category and the network protocols; obtain device data corresponding to the device and including state data of the device; analyze the device data to determine at least one statistic value for the state data of the device; and modify the device timeout based on the at-least-one statistic value. The device data may be obtained during a predetermined observation window of time. The state data of the device may be related to one of an offline state and an online state. The state data of the device on the network may include at least one of a number of changes to a state of the device and a duration associated with the state of the device. The at least one statistic value may include a maximum number of changes to a state of the device during the predetermined observation window of time, and wherein the device timeout may be modified based on the maximum of the number of changes to the state of the device. The at least one statistic value may include a maximum offline duration of the device during the predetermined observation window of time, and wherein the device timeout may be modified based on the maximum offline duration of the device. The statistic value may be one of a maximum number of changes to the state of the device, a minimum offline duration of the device, a maximum offline duration of the device, an average offline duration of the device, and a median offline duration of the device.

In accordance with a further aspect of an embodiment of the invention, a computer-implemented method is provided that includes the steps of: obtaining, using a presence detection system, device data corresponding to a device on a network; analyzing, using the presence detection system, the device data to determine a coefficient of adhesion of the device to the network; and determining state data of the device based on the coefficient of adhesion. The state data of the device may be related to one of an offline state and an online state. The method may also include the steps of setting a threshold based on the type of network; comparing the threshold to the coefficient of adhesion of the device to the network; and determining, based at least on the step of comparing the threshold, the state data of the device on the network. The method may also include the steps of: setting a threshold based on the type of the network; comparing the threshold to the coefficient of adhesion of the device to the network; and determining, based at least on the step of comparing the threshold, whether the device is a guest or a native of the network. The coefficient of adhesion may be based on a weight assigned to each of a set of events occurring on the network, and the coefficient of adhesion may be indicative of a probability that the device is connected to the network. The coefficient of adhesion may be calculated using a weighted averaging formula based on the weight assigned to each of the set of events occurring on the network.

### BRIEF DESCRIPTION OF THE DRAWINGS

Various embodiments in accordance with the present disclosure will be described with reference to the drawings, in which:

FIG. 1 is a block diagram of a system for collecting device information on a network to predict the presence of devices on the network;

FIG. 2 illustrates a data structure for a device identifier, specifically a MAC address;

FIG. 3 is a flow chart of a method of detecting the digital presence of devices on a network;

FIG. 4 is a protocol stack diagram;

FIG. 5 is a flow chart of a method of determining device absence; and

FIG. 6 illustrates a set of basic components of a computing device that can be utilized to implement aspects of various embodiments of the present invention.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without all of the specific details described. Furthermore, well-known features may be omitted or simplified in order not to obscure the embodiment being described.

Embodiments of the present invention provide techniques, including systems and methods, for detecting the digital presence of devices connected to, or otherwise “on,” a network. Digital presence detection may also involve implementing an algorithm and related software architecture to detect the presence of individuals in a defined area such as a home or an office, based on the detection of a device in or near a wired or wireless network. Based on the networking properties of such a device, it may be possible to ascertain the absence, presence or general or specific location of a device or an individual, track the duration of a device's or person's presence in an area, and inform automated systems about the changes of premises, without the need of an additional locating device or personal tracker.

Digital presence detection includes techniques for detecting and identifying devices that connect to a network, preferably for accessing online content on the network, and their and their properties/characteristics. Detecting the digital presence of devices connected to a network or within a geographic area provides many advantages and benefits. Embodiments of the present invention include improved techniques for providing content that is accessible to users across a plurality of devices, types of devices, operating systems, browsers, etc. based on their detected, determined, or estimated digital presence. Digital presence detection may facilitate resolution of technical problems users encounter when attempting to access online content using different devices (e.g., viewing a website from a laptop compared to viewing the website from a mobile phone) or switching between devices. Depending on the type of device used to access the content, the format or layout of the content may not be suitable for the particular device, or the website may not be compatible with the browser or the device. Information about users can also be collected, correlated, extrapolated, and deduced from information regarding the users' digital presences across different networks and locations based on the detection and identification of the users' devices and the devices' properties/characteristics.

Embodiments of the present invention also include improved techniques of detecting the digital presence of devices on networks for multiple applications such as, for example, providing targeted content to users by identifying them based on the digital presence of their devices. For example, data about which device users are using to access the online content of a business can be valuable to the business in determining how to market and/or advertise their products/services, how to improve their products/services, and how to provide products/services to their users. Identification of the devices used to access various types of data, and the properties/characteristics of the devices, can be analyzed to reveal other characteristics of the users themselves such as, for example, demographic data. User data obtained or extrapolated from the device identifying data can be further used to predict other types of content particular users or groups of users may be interested in. For example, the type of device identified may be correlated with users of a particular socio-economic group and therefore advertising and search results could be adjusted based on statistically predicted relevance to that particular group. Such predictions regarding user interests and other user characteristics can be used by machine learning algorithms to determine relevant and targeted content for specific users.

The widespread diffusion of local-area computer networks, both wireless and wired, has enabled the creation of a map of networks that can identify a place with a certain level of precision. For example, a Local Area Network (LAN) can be assigned to a geographical location with a given accuracy, such as the size of the geographic area that the network can effectively reach. Additionally, with mobile devices becoming more ubiquitous, mobile devices are being transported and interacting with a plurality of different local networks, both wired and wireless. The mobile devices may automatically interact with those local networks, which may be used to track the presence, absence or general or specific location of such devices. Detecting the digital presence of devices on a network can facilitate the implementation of an algorithm that relies on identifying devices and linking the identified devices to specific users. Digital presence detection may be conducted either manually or automatically by collecting a flow of information/data from devices detected on the networks, which may be used to track the presence of the devices over time and the individuals associated with those devices.

Embodiments of the present invention also include improved techniques of detecting the digital presence of devices on a network. Detecting the digital presence of devices used by specific users on a network may be cross referenced with a device database. Depending on the device database, digital presence detection data can be used to identify devices and users and to determine specifications of the connected devices and characteristics of their users. Information valuable to product and service providers can be determined from sparse device information gathered from merely detecting which devices are connected to a network. That information can be used in various applications such as, for example, Internet-of-Things (IoT) systems, consumer retail applications, insurance, device theft and fraud detection and recovery, etc.

Embodiments of the present invention resolve the technical problem of inaccurate device identification by using a preferably unique, assigned identifier (e.g., MAC address) instead of HTTP standard user-agent strings. Device identification information can be obtained more quickly and accurately, resulting in better data for prediction analysis and better accuracy in identifying and characterizing users based on their device data.

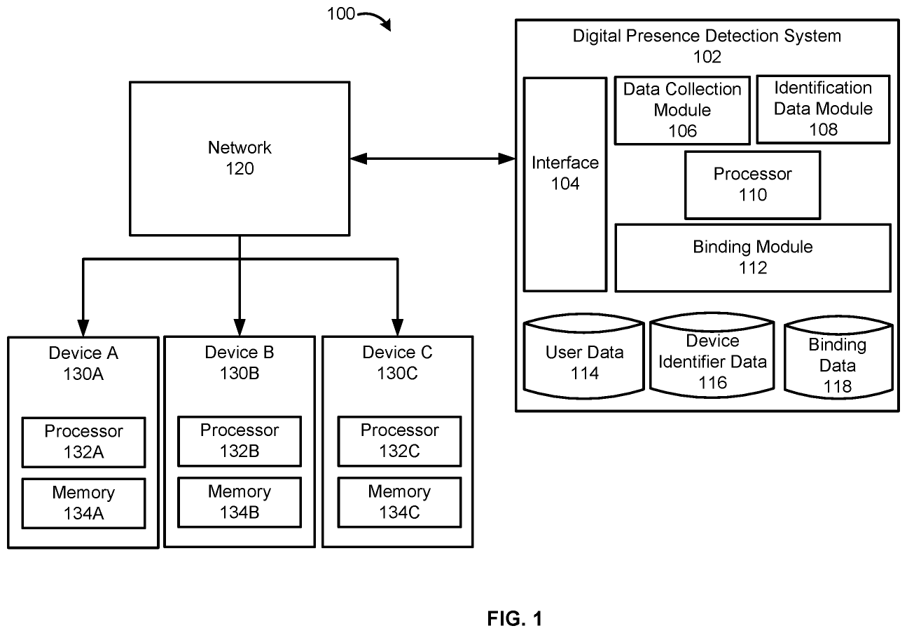

FIG. 1 illustrates a system 100 for digital presence detection of devices on a network, in accordance with an embodiment of the present invention. The system 100 may include a digital presence detection system 102 that is connected to a network 120, such as the Internet. The network 120 can be any network to which devices, systems, servers, computers, etc. can connect in order to communicate with each other. Multiple devices, such as Device A 130A, Device B 130B, and Device C 130C, may be connected to the Internet 104. Each device 130A, 130B, and 130C may have a respective processor 132A, 132B, and 132C and a respective memory 134A, 134B, and 134C, on which the individual device's identification information may be stored.

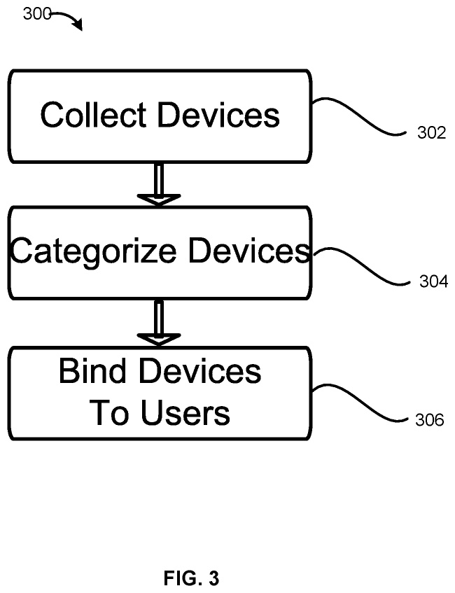

The digital presence detection system 102 may interface with the network 120 through an interface 104. The digital presence detection system 102 may include a processor 110 and a memory (not shown) that stores executable instructions to perform specific operations and functions. For example, the digital presence detection system 102 may include a data collection module 106 that is configured with executable code to collect device data associated with devices connected to, or otherwise “on” or part of, network 120 (e.g., see FIG. 3). Data collection module 106 may scan network 120 to gather data from one or more devices on network 120. The digital presence detection system 102 preferably includes identification data module 108 that extrapolates (e.g., deduces, calculates, estimates, predicts, correlates, retrieves from a database, and the like) device identification information from the raw data that is collected by data collection module 106. For example, device identification information, such as a media access control (MAC) address, may be extrapolated by identification data module 108. Collected raw data may be stored in a collected data cache and/or database (not shown), while corresponding device identification data (e.g., MAC address) may be stored in a device identifier data database 116. The MAC address of a device is preferably a unique identifier assigned to network interfaces for communications at the data link layer of a network. MAC addresses are used as a network address for most IEEE 802 network technologies, including Ethernet and Wi-Fi. A network node may have multiple network interfaces and each one preferably should have a unique MAC address.

The digital presence detection system 102, after identifying devices connected to network 120, may perform a user binding analysis on the collected device information. This process binds, or links, identified devices on network 120 to particular users based on a user data database 114 of registered users, accounts, historical users, and/or previously detected users or the like. The binding process is performed by binding module 112 that can access the user data database 114 and device identifier data database 116. Binding module 112 determines specific users or accounts to be linked to, or associated with, particular device identifiers, binds them together, and stores the binding (e.g., paired data or linkage) in binding data database 118. For example, an individual user may be bound to a personal smartphone identifier, a work smartphone identifier, and a wi-fi only tablet identifier. In an alternate embodiment, the digital presence detection system 102 may access or communicate with a separate user information database (not shown) and cross-reference stored user information data with data in device identifier data database 116, data in user data database 114, and/or data in binding data database 118. Further, digital presence detection system 102 may perform statistical analyses and other data analysis on user data information, such as user demographics, to determine correlations between users and device information. The results of the analyses may be used to create predictive models of user behavior, to identify links between users and specific devices, to identify devices on or across different networks, to identify relevant content to the users, to create targeted services for users, etc.

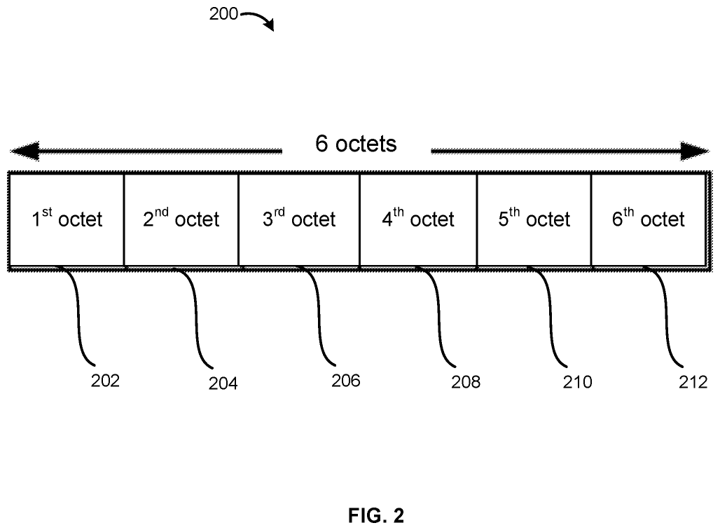

FIG. 2 illustrates a data structure 200 for a device identifier, specifically a MAC address. A MAC address of a device is preferably a unique identifier assigned to network interfaces for communications at the data link layer of a network. MAC addresses may be used as a network address for most IEEE 802 network technologies, including Ethernet and Wi-Fi. MAC addresses are most often assigned by the manufacturer of a network interface controller (NIC) and may be stored in the NIC hardware. For example, the MAC addresses may be stored in a NIC card's read-only memory or some other firmware mechanism in the NIC. MAC addresses that are assigned by the manufacturer typically encode the manufacturer's registered identification number such as, for example, a burned-in address (BIA), an Ethernet hardware address (EHA), a hardware address or a physical address. Unlike a programmed address, where a host device issues commands to the NIC to use an arbitrary address, the MAC address is preferably uniquely assigned to the hardware device, as MAC addresses are permanently burned into hardware by the hardware manufacturer.

A network node may have multiple NICs and each NIC preferably has a unique MAC address. Sophisticated network equipment such as a multilayer switch or router may have one or more permanently assigned MAC addresses. MAC addresses are formed according to the rules for numbering name spaces managed by the Institute of Electrical and Electronics Engineers (IEEE): MAC-48, EUI-48, and EUI-64. A MAC address is preferably a globally unique identifier assigned to network devices, and therefore is often referred to as a hardware address or a physical address. MAC addresses are 6-bytes (48-bits) in length, and are written in MM:MM:MM:SS:SS:SS format. A byte has eight bits, and in FIG. 2, each byte is referred to as an octet. The first 3 bytes 202, 204, and 206, are an identification (ID) number of the manufacturer which is assigned by an Internet standards entity. The second 3-bytes 208, 210, and 212, are a serial number assigned by the manufacturer to the device.

The first three octets (in transmission order) 202, 204, and 206, identify the organization that issued the identifier and are known as the Organizationally Unique Identifier (OUI). The remainder of the address 208, 210, and 212, are assigned by the corresponding organization (three octets for MAC-48 and EUI-48 or five for EUI-64 (not shown). According to a preferred embodiment, the digital presence detection system implements an algorithm that analyses the remainder of the address (last three octets: 208, 210, 212) by training supervised machine learning ensembles to create decision trees that enable a prediction/classification model to predict specific and detailed device properties (e.g., type, brand, family, and model) from a relatively small set of device data collected from a limited number of devices connected to a network.

Typically, a device that needs to interact with a network has at least one MAC address that is used to advertise its presence, obtain other types of addresses for higher protocol levels, and exchange data. Excluding addresses for virtual devices, the MAC addresses are typically hard-coded by the device manufacturer and uniquely assigned to a single device, making it a stable and un-modifiable identifier. Preferably, a digital presence detection system may use MAC addresses to uniquely identify devices, regardless of the computer network they are communicating or interacting with.

FIG. 3 is a flow chart of a method 300 of detecting the digital presence of devices on a network, in accordance with an embodiment of the present invention. A MAC address may help identify a device connected to a network, but using only a MAC address may not easily identify the type of device or whether it would confirm the presence and location of a user. Networks may often have hundreds or more active devices connected. Preferably, the digital presence detection system can identify user devices that can actually confirm the presence of the user. Because a user may use multiple mobile devices at any given time, the detection of the presence of certain devices may not be indicative of the actual location of the user. The digital presence detection system preferably identifies devices that are usually carried by (or in proximity to) the user, making them an effective proxy for tracking the location of the user. As an example, detecting the presence of a mobile communication device or smart watch connected to a network may be useful for tracking the location of a user because the user carries them. In contrast, a gaming console or a television, while it could be used, owned, and/or associated with a single user, may not identify the location of a user based on the detection of the console or television's presence/proximity/absence, because it is not carried by the user and it may be turned off when not needed.

In another example, a user may have a mobile phone for personal use, another mobile phone for professional use, and a tablet computer. Not all of these devices may be useful for tracking the location of the user because some devices may not be as relevant in determining the location of the user or other information that may be gathered by identifying that particular device. For example, the user may only carry the work phone during the weekdays and may not bring the work phone on weekends. In another example, the user may share a tablet computer with other family members (e.g., children), use the tablet computer exclusively at home for reading, or as a replacement for a laptop computer when traveling, etc. Comparing the personal mobile phone, work mobile phone, and tablet computer in this hypothetical scenario, the personal mobile phone may be most useful in determining the user's location because the user carries it at all times (i.e., at home, at work, on vacation, etc.) and it is used exclusively by the user. The tablet computer may not be as relevant since it is mostly left at home regardless of where the user is. After confirming the digital presence of a device that correlates highly with, or is otherwise a useful proxy for, the user's location (a “Tracker Device”), the digital presence detection system may bind the identified Tracker Device to the specific user.

At step 302, the digital presence detection system may first implement a device data collection process. Data about devices connected to a network may be manually collected. For example, a user may enter one or more device details manually into the digital presence detection system or network, including the MAC address(es) of the user's device(s). Alternatively, in another embodiment, the digital presence detection system may automatically collect device details (e.g., MAC addresses) from devices connected to the network. To conduct an automatic collection of device data, the digital presence detection system may have a probe connect to the network. The probe may be implemented in either software, hardware, or a combination of both. The probe may scan the local area network to collect network information, for example, using the MAC address of each device detected. The probe may collect other publicly-available network information through several different protocols, including DHCP, NetBIOS, Bonjour, UPnP, DNS, SNMP, HTTP, HTTP User Agent, Wi-Fi probes, and the like. At the end of the device data collection process, the system will have collected a set of network records identified by MAC address.

At step 304, the digital presence detection system may subsequently implement a device categorization process to sort and rank the best candidate devices for selection as Tracker Devices for one or more users. In one embodiment, device categorization may be conducted manually by a user to categorize device records that correspond to mobile devices that are Tracker Devices. In another embodiment, the digital presence detection system may implement automatic categorization of device records, preferably where each device record is analyzed individually and protocol-specific classification rules are applied. The automatic categorization algorithm may not specify exclusively what method must be used to perform the categorization, and multiple categorization methods may be used in parallel or in sequence to perform the automatic categorization. At the end of the device categorization process, preferably a list of network records for Tracker Devices have been identified as candidates to be bound to specific users.

At step 306, the digital presence detection system implements a user binding process. Preferably, personally-identifiable records of users are bound to network-identifiable records of device data for devices that can be detected when connected to a network. In one embodiment, binding may be conducted manually. For example, a user may manually define main user properties including, but not limited to, username, user avatar, user category, user age, user gender, and/or a network record for a respective Tracker Device. Preferably, the user selects from a set of network records obtained in step 304 that includes the Tracker Device(s) to be used for personal identification of a particular user. In another embodiment, binding may be conducted automatically. For example, a user may grant access to a list of already identified and defined users, such as the user's contact list. The contact list may be available locally on a local device (e.g., smartphone) or available remotely on a cloud-based service. Alternatively, an external data source such as third-party application or a third-party cloud service provides a contact list or other appropriate file containing user contact information. The digital presence detection system preferably implements an algorithm that determines a set of best-matching bindings between the set of network records obtained in step 304 and the contact list provided by the user or a third-party source.

The algorithm determining the best-matching bindings may be based on matching for example, contact names or other personal information with device names, frequency of device usage values, or device usage statistics on most common usage, or the like. Matching bindings may be based on device categorization and/or user profiles, user genders, user ages, or other user information, or the like. Alternatively, the binding algorithm may perform matching in different orders, for example starting from user definitions and collecting and categorizing devices based on the restrictions that the user definitions may have provided, such as username, user age, user gender, other user demographic data and the statistical probabilities in categorizing devices based on these restrictions.

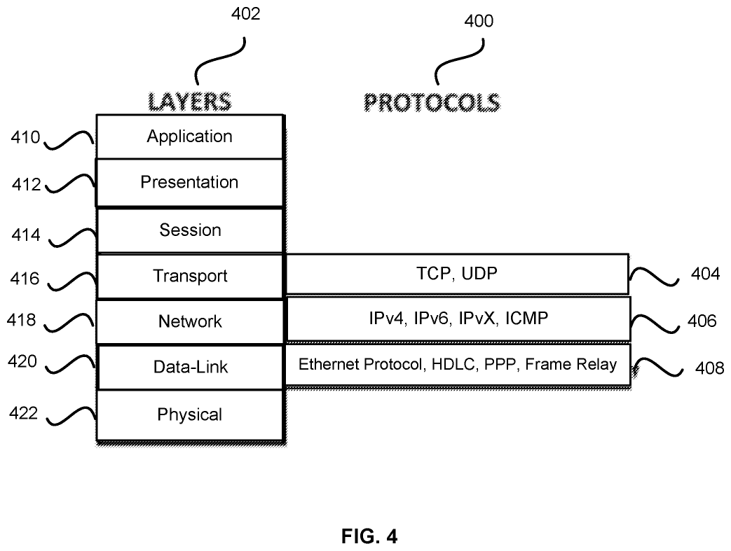

FIG. 4 illustrates a protocol stack diagram 400, in accordance with embodiments of the present invention. According to one embodiment, the digital presence detection system may constantly monitor a network for wired and/or wireless communications. In order to detect and react to network changes involving devices connecting, disconnecting, changing connections, or the like, the digital presence detection system may include a software and/or hardware module that regularly monitors the network to detect if Tracker Devices are connected to the network or near network components or other devices connected to the network. The digital presence detection system may include several steps. For example, a software/hardware detection module may monitor and detect devices. The detection module may monitor and detect constantly or on a periodic schedule. The digital presence detection system may then implement a query/lookup process to map devices to users. In an alternate embodiment, the digital presence detection system may include a notification system that informs a third party entity or service about the presence or absence of digital devices on the network.

The digital presence of a device can be detected when the device is online (i.e., connected to or otherwise on a network). Online presence can be determined through the transmission of at least one network packet on any number of media layers 401 using one or more protocols 402, such as an application layer 410, presentation layer 412, session layer 414, transport layer 416, network layer 418, data link layer 420, and physical layer 422. The transmission may be a wired or wireless communication. For example, transport layer 416 may implement different protocols such as Transmission Control Protocol (TCP) or User Datagram Protocol (UDP) 404. TCP is a standard that defines how to establish and maintain a network conversation by which application programs can exchange data. TCP works with the IP, which defines how computers send packets of data to each other. UDP is a minimal message-oriented transport layer protocol that provides no guarantees to the upper layer protocol for message delivery and the UDP layer retains no state of UDP messages once sent. Examples of protocols for network layer 418 include IPv4, IPv6, IPvX, and Internet Control Message Protocol (ICMP) 406. ICMP is a supporting protocol in the Internet protocol suite, and may be used by network devices, including routers, to send error messages and operational information indicating, for example, that a requested service is not available or that a host or router could not be reached. Examples of protocols for data link layer 420 include Ethernet protocol, High-Level Data Link

Control (HDLC), Point-to-Point Protocol (PPP), and frame relay 408. HDLC is a bit-oriented code-transparent synchronous data link layer protocol developed by the International Organization for Standardization (ISO). PPP is a data link layer (layer 2) communications protocol used to establish a direct connection between two nodes in a network.

In order to monitor the communications within a local area network, preferably the digital presence detection system implements a monitoring software. The monitoring software may execute and run on common or specialized hardware. The monitoring software may operate by sending network packets to the network, and listening to network packets sent over the network at various network layers to determine what devices are currently connected to the network. By recognizing devices connected to the network having one or more of MAC addresses collected, categorized and bound to a user (described above), the digital presence detection system can infer the presence of an individual at the network's location.

In a preferred embodiment, the digital presence detection system may augment device detection through wireless monitoring. Under several circumstances, wireless mobile devices may disconnect from a network to preserve battery charge and reduce the usage of wireless network interfaces. Additionally, a device may inform the wireless access point that it is dropping off the network, and request to be woken up only when some particular data is available. When such disconnections occur, to avoid erroneously classifying a device as absent from the network, the digital presence detection system, according to a preferred embodiment may augment its digital detection analysis with an additional wireless network adapter. The digital presence detection system may connect to the network in “monitoring mode” such that it is possible to listen to Ethernet packets sent over-the-air, and infer the location of the device in relation to the network, irrespective of the fact that the device may or may not be connected to the network at that moment. The digital presence detection system may merge the results of a wired/wireless network discovery performed inside a Local Area Network (LAN) with the analysis of wirelessly transmitted packets, which significantly improves device detection in case of network drop-offs (dropped connectivity) as well as physical location detection. The network discovery analysis described above also is applicable when the device is physically near the network (i.e., in the vicinity), but has not (or could not be) connected to the network.

According to another embodiment of the present invention, the digital presence detection system may augment device detection with other sources of information, for example using geolocation information provided by GPS systems, IP Address geocoding, connections to different networks, information sent or collected through third party applications, and/or statistical behavior analysis.

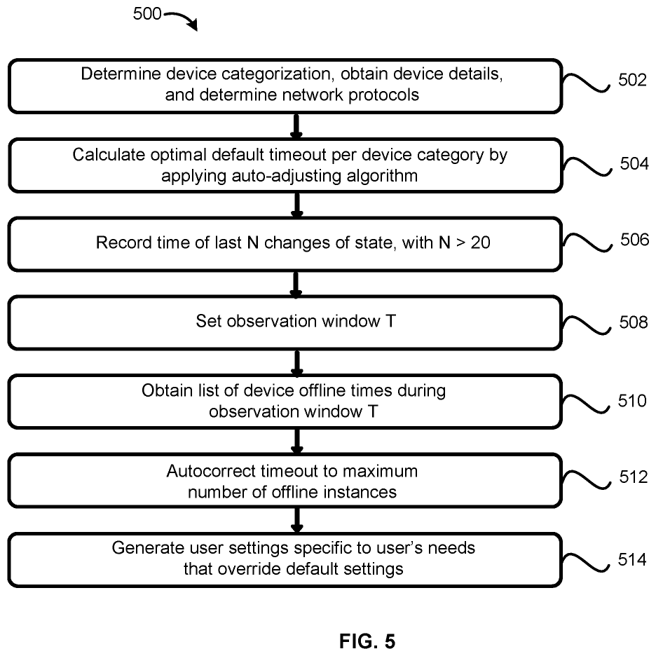

FIG. 5 illustrates a flow chart of a method 500 of determining device absence, in accordance with an embodiment of the present invention. Online absence (that is, being detected as offline) may be more complex than detecting device presence on a network, as typically it may be based on the absence or lack of information. Most network infrastructures do not require informing the network that a device is leaving the network. A digital presence detection system may utilize timers to calculate the amount of time each device has been silent, and react when a timeout expires. In order to optimize and tune the digital presence detection system, the system employs automatically adjustable and dynamic settings based on the behavior of devices connected to the network, such as wake-up and sleep times to prevent false positives.

At step 502, device categorization may be determined based on details obtained from a device manufacturer. As discussed in connection with FIG. 3, the digital presence detection system may perform a device categorization, and obtain supplemental details from the device manufacturer. With such information a determination of a category of the device detected on a network may be made. As discussed and shown in FIG. 4, the digital presence detection system may determine network protocols utilized by the different categories of devices. A determination of network protocols utilized by the device on the network based on the category of the device may be made.

At step 504, the digital presence detection system may calculate an optimal default timeout per device category by employing an automatically adjusting algorithm. The automatically adjusting algorithm collects data regarding devices connected to the network to determine an initial default device category timeout and adjust that timeout value based on subsequently obtained data. Based on the device category and network protocols obtained in step 502, an initial default device category timeout is retrieved from a database or calculated using known techniques. The initial default device category timeout may be set as the default timeout for any device in the associated category. The default device timeout for the device may be updated by calculating actual (or more precise estimated) timeouts for the device based on the category of the device, the network protocols utilized by the device, and its network performance. For example, the digital presence detection system may also implement a statistical analysis based on large amounts of actual device data. The statistical analysis may include calculation of the minimum, maximum, average, mean, median (and other statistically relevant values) amounts of time each categorized device is present and absent on the network at different times of the day.

At step 506, the digital presence detection system may record the time the last N changes of state occurred, with preferably N>20. At step 508, an observation window T may be set, with T being a tuning value preferably greater than two hours but less than 12 hours. At step 510, the digital presence detection system may obtain the list of offline times (e.g., O1, O2, . . . On) during the observation window T. At step 512, the timeout may be autocorrected to a maximum number of offline instances or a maximum offline time less than a threshold global maximum value. At step 514, the digital presence detection system may then generate user settings specific to the user's needs, overriding the default settings. In this way, device data corresponding to the device on the network, including state data (e.g., data related to the device being in an online state, an offline state, times of occurrence of these states, and the like) of the device, may be obtained and the data may be analyzed to determine one or more statistics related to the state data. The timeout associated with the device may be modified based on the one or more statistics.

In another embodiment, other higher-level functionalities may be implemented by the digital presence detection system, such as qualifying the digital presence. The digital presence detection system may identify the state of the device and its user (e.g., additional details regarding each), based on an analysis of data collected during a relatively small time window. Based on a preserved historical record of the state changes of the device and its user, the digital presence detection system may run a statistical evaluation to generate a higher-level analysis of additional properties and behavioral patterns of each. The higher-level analysis may include more complex information as opposed to providing only binary present/absent determinations regarding the device, its user, and properties of each.

Qualifying the nature of a device presence may be able to discriminate whether a device is “native to the network” (e.g., belonging to people living in the household, working at the office, or in any way considered a regular user of the network), or if a device is a “guest to that network” (e.g., its presence may be new, rare, or infrequent). The qualifying method may be implemented during a time window of digital presence detection where there is a change of events preferably in the last 30 to 60 days. For example, the digital presence detection system may analyze: the matrix of hourly presences per device, the matrix of daily presences per device, or the categorization of the device type, as returned by the categorization phase of the algorithm described above. As such, for each fraction of time, the digital presence detection system may deduce if the device may be mobile or fixed (e.g., wireless or wired), the amount of times the device has been online per day and per hour, and obtain a “coefficient of adhesion” to the network (described in more detail below). Preferably, a low coefficient of adhesion to the network indicates an infrequent presence and a high value indicates a regular presence. For each type of network, a different threshold and/or time window may be used to determine the nature of the visit as “guest” or “native” to the network.

In a similar process, the digital presence detection system may qualify the temporal behavior of the device and/or its user based on the coefficient of adhesion. For example, the digital presence detection system may identify whether: the device has been seen only on a single day, the device has been seen regularly on the same weekday, the device has been seen only for long visits, the device has been seen only for short visits, and/or the device has been seen only for workdays or weekends. Beyond being “seen” the system may identify particular user actions or interactions on similar time scales, e.g., uses, clicks, views, network activity, and the like.

In addition to events that can identify the presence of a device (e.g., identifying the device as being “online” rather than “offline”) within the network when the connectivity of the device is reliable, there may be events that can help identify the presence of the device within the vicinity of the network (e.g., at or near the location of the network) when the connectivity of the device is unreliable or otherwise intermittent. Such identification of the presence of the device within a network's vicinity may be possible despite the connectivity of the device being faulty, frequently dropping, or being in any way unreliable or otherwise intermittent. As examples of such events, according to the IEEE 802.11 standard, the wireless network card of the device may send on the 2.4 GHz and/or 5 Ghz frequency bands regular signals which may each constitute an event for analysis. These signals may be received by the digital presence detection system and analysed. Such signals may be passively (as a result of sending/receiving a beacon) and/or actively (as a result of querying/determining which device is on a specific Wi-Fi channel) received by the system.

There may be multiple other types and occurrences of the aforementioned events that can identify the presence of the device within the vicinity of the network when the connectivity of the device is unreliable or otherwise intermittent. Examples of such types of events may include: (1) the device responding to a direct query, such as, for example, when the device attempts to ICMP Ping request the support of a well-known service; (2) the device reacting to a broadcasted or multicast request, such as, for example, when the device posts a broadcast request for UPnP (Universal Plug and Play) and receives a response; (3) the device sending spontaneous requests (i.e., spontaneous events), such as, for example, when the device posts a gratuitous ARP request.

It is to be noted, that for purposes of determining the presence of a device and/or a user, the events and their related weights may depend on the category of the device. In order to determine if a device is online on the network, the digital presence detection system (employing, for example, a digital presence algorithm) may assign a weight to each such type of event that it detects. The weight may be used to calculate (e.g., using a weighted averaging technique to weight occurrences of each type of event) the probability that a given device may actually be within the network and “online,” rather than “offline.” The detection of such example events (1)-(3), above, may allow for the determination by the digital presence detection system, with a very high degree of certainty, that the device is present or “online” in the network. This may be because such events may be assigned a high weight, and may increase the probability that the device is “online” within the network. Detected events, which relate to wireless packets being transmitted by a device, may have a variable weight depending to what extent analysis of the wirelessly transmitted packets reveal that the packets carry information that is suitable or valid to confirm the presence of the device on the network (i.e., that the device is “online” within the network). In some cases the analysis of such wirelessly transmitted packets may reveal that the packets carry information that is not suitable or valid to confirm the presence of the device on the network, and such events may be assigned a nominal weight value, which may get nullified or ignored when calculating the coefficient of adhesion.

The events discussed above may be merged together in a weighted formula (e.g., a weighted averaging formula which adds the number of each type of event multiplied by the weight associated with that event and then divides by the total number of events) to calculate an indicator (i.e., a coefficient) of the probability that the device is connected to a network or “online” on the network. This indicator may be referred to as a “coefficient of adhesion” of the device to the network. Advantageously, such a coefficient of adhesion may be computed despite the device temporarily dropping its signal or reducing its transmission power in order to save energy. Low values of the coefficient of adhesion may indicate an infrequent presence and high values of the coefficient of adhesion may indicate a regular presence. One or more thresholds may be set for the coefficient of adhesion. As an example, a threshold and/or specific events occurring may be used to determine an online or an offline state of the device on the network. For example, a coefficient of adhesion of a device that is above a threshold may indicate that the state of the device is “online” on the network, whereas a coefficient of adhesion of a device that is below a threshold may indicate that the state of the device is “offline.” Another threshold may be set and used to determine whether the device is a “guest” on the network or “native” to the network. The thresholds may be dependent on the type of network (e.g., a reliable wired network, an unreliable wireless network, a long range network, a short range network, etc.). For example, a coefficient of adhesion that is above the threshold may indicate that the corresponding device is “native” to the network, whereas a coefficient of adhesion of a device that is below the threshold may indicate that the device is a “guest” on the network. In addition, the coefficient of adhesion may be used to calculate or to modify the timeout of the device, for example, based on the determined device state data (e.g., whether the device is in an online state or an offline state, for example).

In general, identifying the presence of a device within the vicinity of the network when the connectivity of the device is unreliable is more complex than simply identifying as “online” only the devices having reliable connectivity that reply to specific requests. The technique, as described above, of calculating and using a coefficient of adhesion of a device may allow for additional reliability and stability in determining the state of a device or other information about the device's presence on the network. This may be especially true in environments where the physical vicinity of a device's wireless card can still be detected, despite the connectivity of the device to a specific network being intermittent or completely dropped.

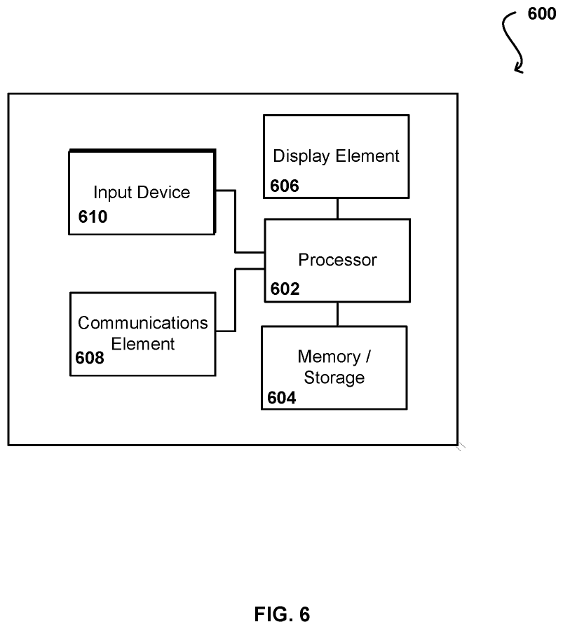

FIG. 6 illustrates a set of basic components of an example computing device 600 that can be utilized to implement aspects of the various embodiments of the invention. The device may include at least one type of display element 606. Examples of display elements 606 can include a touch screen, electronic ink (e-ink), organic light emitting diode (OLED) or liquid crystal display (LCD), although devices such as servers might convey information via other means, such as through a system of lights and data transmissions. The device can include at least one input device 610 able to receive input from a user. This conventional input can include, for example, a push button, touch pad, touch screen, wheel, joystick, keyboard, mouse, trackball, keypad or any other such device or element whereby a user can input a command to the device. These I/O devices could even be connected by a wireless infrared or Bluetooth or other link as well in some embodiments. In some embodiments, however, such a device might not include any buttons at all and might be controlled only through a combination of visual and audio commands such that a user can control the device without having to be in contact with the device. The device can include many types of memory, data storage or computer-readable media, such as a first data storage for program instructions for execution by the at least one processor 602, the same or separate storage can be used for images or data, a removable memory can be available for sharing information with other devices, and any number of communication approaches can be available for sharing with other devices. The at least one processor 602 may be capable of executing instructions that can be stored in a memory device or element 604. To connect to networks, both wired and wireless, the device typically will include one or more communications elements 608, such as a networking component, port, network interface card, or wireless transceiver that enables communication over at least one network.

Different approaches can be implemented in various environments in accordance with the described embodiments. Embodiments may implement a Web-based environment, or other suitable environment. The system includes an electronic client device, which can include any appropriate device operable to send and receive requests, messages or information over an appropriate network and convey information back to a user of the device. Examples of such client devices include personal computers, mobile phones, handheld messaging devices, laptop computers, set-top boxes, personal data assistants, tablets, electronic book readers and the like. The network can include any appropriate network, including an intranet, the Internet, a cellular network, a local area network or any other such network or combination thereof. Elements or components used for such a system can depend at least in part upon the type of network, communication protocols, communication components, and/or environment selected. In this example, the network includes the Internet, as the environment includes a Web server for receiving requests and serving content in response thereto, although for other networks, an alternative device serving a similar purpose could be used, as would be apparent to one of ordinary skill in the art. Communication over the network can be enabled via wired or wireless connections and combinations thereof. It should be appreciated that the methods and systems as discussed herein have the ability to more quickly and more accurately determine and modify a timeout of a device on a network, and/or determine or modify a coefficient of adhesion, and/or state information of a device on the network than currently known techniques, thereby decreasing computer processing power needed for such determinations/modifications as well as decreasing the error rate and increasing a confidence score associated with such timeout and/or coefficient of adhesion determinations/modifications. Furthermore, it should therefore be appreciated that the methods and systems as disclosed herein surpass what is considered well-understood, routine, or conventional.

The illustrative environment includes at least one application server and a data store. There can be several application servers, layers or other elements, processes or components, which may be chained or otherwise configured, which can interact to perform tasks such as obtaining data from an appropriate data store. “Data store” may be any device or combination of devices capable of storing, accessing and retrieving data, which may include any combination and number of data servers, databases, data storage devices and data storage media, in any standard, distributed or clustered environment. The application server provides access control services in cooperation with the data store and is able to generate content such as text, graphics, audio and/or video to be transferred to the user, which may be served to the user by the Web server in the form of HTML, XML or another appropriate structured language in this example. The application server can include any appropriate hardware and software for integrating with the data store as needed to execute aspects of one or more applications for the client device and handling a majority of the data access and business logic for an application. The handling of all requests and responses, as well as the delivery of content between the client device and the application server, can be handled by the Web server. It should be understood that the Web and application servers are not required and are merely example components, as structured code discussed herein can be executed on any appropriate device or host machine as discussed elsewhere herein.

The data store can include several separate data tables, databases or other data storage mechanisms and media for storing data relating to a particular aspect. For example, the data store illustrated includes mechanisms for storing content (e.g., production data) and user information, which can be used to serve content for the production side. In another example, the data store may include a mechanism for storing log or session data. There can be many other aspects that may need to be stored in the data store, such as page image information and access rights information, which can be stored in any of the above listed mechanisms as appropriate or in additional mechanisms in the data store. The data store is operable to receive instructions from the application server and obtain, update or otherwise process data in response thereto.

Each server typically may include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more

Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, magnetic tape drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method, the method comprising the steps of:
determining a category of a device on a network;
determining network protocols utilized by the device based on the category;
calculating a device timeout for the device based on the category and the network protocols;
obtaining, using a presence detection system, device data, corresponding to the device and including state data of the device;
analyzing, using the presence detection system, the device data to determine at least one statistic value for the state data of the device; and
modifying the device timeout based on the at least one statistic value.

2. The method of claim 1, wherein the device data is obtained during a predetermined observation window of time.

3. The method of claim 1, wherein the state data of the device is related to one of an offline state and an online state.

4. The method of claim 1, wherein the state data of the device includes at least one of a number of changes to a state of the device and a duration associated with the state of the device.

5. The method of claim 2, wherein the at least one statistic value includes a maximum number of changes to a state of the device during the predetermined observation window of time, and wherein the device timeout is modified based on the maximum of the number of changes to the state of the device.

6. The method of claim 2, wherein the at least one statistic value includes a maximum offline duration of the device during the predetermined observation window of time, and wherein the device timeout is modified based on the maximum offline duration of the device.

7. The method of claim 1, wherein the statistic value is one of a maximum number of changes to the state of the device on the network, a minimum offline duration of the device, a maximum offline duration of the device, an average offline duration of the device, and a median offline duration of the device.

8. A presence detection system comprising:
a processor; and
a non-transitory computer-readable medium storing instructions executable by the processor to:
determine a category of a device on a network;
determine network protocols utilized by the device based on the category;
calculate a device timeout for the device based on the category and the network protocols;
obtain device data, corresponding to the device and including state data of the device;
analyze the device data to determine at least one statistic value for the state data of the device; and
modify the device timeout based on the at least one statistic value.

9. The system of claim 8, wherein the device data is obtained during a predetermined observation window of time.

10. The system of claim 8, wherein the state data of the device is related to one of an offline state and an online state.

11. The system of claim 8, wherein the state data of the device includes at least one of a number of changes to a state of the device and a duration associated with the state of the device.

12. The system of claim 9, wherein the at least one statistic value includes a maximum number of changes to a state of the device during the predetermined observation window of time, and wherein the device timeout is modified based on the maximum of the number of changes to the state of the device.

13. The system of claim 9, wherein the at least one statistic value includes a maximum offline duration of the device during the predetermined observation window of time, and wherein the device timeout is modified based on the maximum offline duration of the device.

14. The system of claim 8, wherein the statistic value is one of a maximum number of changes to the state of the device, a minimum offline duration of the device, a maximum offline duration of the device, an average offline duration of the device, and a median offline duration of the device.

15. A computer-implemented method, the method comprising the steps of:
obtaining, using a presence detection system, device data corresponding to a device on a network;
analyzing, using the presence detection system, the device data to determine a coefficient of adhesion of the device to the network; and
determining state data of the device based on the coefficient of adhesion.

16. The method of claim 15, wherein the state data of the device is related to one of an offline state and an online state.

17. The method of claim 15, further comprising the steps of:
setting a threshold based on a type of the network;
comparing the threshold to the coefficient of adhesion of the device to the network; and
determining, based at least on the step of comparing the threshold, the state data of the device.

18. The method of claim 15, further comprising the steps of:
setting a threshold based on a type of the network;
comparing the threshold to the coefficient of adhesion of the device to the network; and
determining, based at least on the step of comparing the threshold, whether the device is a guest to or a native of the network.

19. The method of claim 15, wherein the coefficient of adhesion is based on a weight assigned to each of a set of events occurring on the network, and is indicative of a probability that the device is connected to the network.

20. The method of claim 19, wherein the coefficient of adhesion is calculated using a weighted averaging formula based on the weight assigned to each of the set of events occurring on the network.
